(19) United States
(12) Patent Application Publication
(10) Pub. No.: US 2026/0162849 A1
(43) Pub. Date: Jun. 11, 2026

(54) AN OFFSHORE HIGH-VOLTAGE ELECTRIC POWER TRANSMISSION ASSEMBLY

(71) Applicant: Aker Solutions Subsea AS, Lysaker (NO)

(72) Inventors: Jan Ole DUNSERUD, Oslo (NO); Ole A. HEGGDAL, Finstadjordet (NO)

(21) Appl. No.: 18/706,904

(22) PCT Filed: Oct. 31, 2022
(86) PCT No.: PCT/EP2022/080381

§ 371 Date: May 2, 2024

(30) Foreign Application Priority Data
Nov. 3, 2021 (NO) 20211326

(51) Int. Cl. H01B 9/00; H01B 7/14

(52) U.S. Cl. CPC H01B 9/006; H01B 7/14

(57) ABSTRACT

An offshore high-voltage electric power transmission assembly, comprising an AC power supply at a first location and with P supply phase lines, a power-receiver with P receiving phase lines at a second location. A high-voltage offshore cable is arranged between the power supply and the power receiver. The first and/or second location is an offshore location. The cable comprises P×N power cores, N and P being two or more. N groups of P power cores connect to the respective P supply phase lines and to the respective P receiving phase lines. The power cores are distributed along a core distribution circle in the cross-section of the high-voltage offshore cable. The order of the P power cores within each of the N groups is identical.

### TECHNICAL FIELD

The present invention relates to an offshore high-voltage electric power transmission assembly with a power-transmitting electric cable. In particular, the invention is applicable at offshore locations, where considerable power shall be transmitted over a large distance.

### BACKGROUND ART

High voltage electric cables are widely used offshore for various purposes. Such purposes include for instance power supply of large electric loads such as subsea pumps or compressors, powering of other offshore facilities, or harvesting electric energy such as from offshore wind turbines or floating solar (PV—photovoltaic) facilities.

Compared to onshore cables, offshore cables may be exposed to significantly larger tensile forces. Moreover, in many applications the cables will be used as dynamic cables, being repeatedly moved by water currents or by waves acting on a floating structure to which the cable is connected. Even if not used as a dynamic cable, many cables will be exposed to tension during installation. This applies in particular when the cable is installed with a vertically extending portion. For instance, a cable for transmitting power from a wind turbine structure resting on the seabed, will have a vertical extension down towards the seabed, along the support structure. Although being fixed to and supported by the structure when in operation, the cable will experience tension during installation.

Typically, the tension experienced by an offshore cable will occur due to its own weight when being suspended in the water with a vertical or inclined orientation.

Consequently, it is common to provide such offshore cables with strength members, such as steel wire armoring and/or steel rods. The strength members and power cores are embedded in elongated filler material, and an outer sheath encircles these inner components.

It is also common to lay the elongated cable components in a continuous helix or with an alternating helical configuration.

When such a cable is stretched, i.e. exposed to tension, it tends to untwist to some extent. That is, when tensioned, the helical configuration is somewhat straightened out. The elongated components which are arranged along the outer periphery of the cable will then not experience as much tension as the inner components. This is due to their spiral configuration. The inner components, however, extend in a spiral configuration with less radius. Hence the inner components are shorter, compared to the outer components.

Common electric offshore three-phase power cables will typically comprise three power cores arranged close to the center of the cable cross section, while elongated strength members are arranged radially outside the power cores. This configuration, having the three power cores arranged close to each other, reduces the electric and magnetic fields induced by the alternating current.

Chinese publication CN102969065A presents a 400 Hz balanced structure cable for ships. Stated objects of the balanced structure cable presented in CN102969065A includes providing a cable that allows a small bending radius, has large current carrying capacity, and which exhibits a small outer diameter. The structure cable is configured to transmit 3-phase power through three pairs of conductors. The conductors are distributed about a cable center where a neutral conductor is arranged. The neutral conductor is provided with a steel wire reinforcing member. Having a small bending radius is beneficial when installing a structure cable in a ship.

Publication CN103646722B discloses a cable for transmission to an aircraft parked on the apron. Aircrafts use a voltage of 115/200 V and a frequency of 400 Hz. The disclosed cable comprises power cores for transmission of three-phase electric power, a neutral core, and control cables. Such cables must tolerate the handling taking place when connecting and disconnecting to the aircraft, such as a pull in the cable, bending and general wear. Corresponding to the '065 publication discussed above, the cable has three pairs of cores to transmit three-phase power. The phase cores are distributed about a centrally arranged neutral core.

An object of the present invention may be to provide an offshore high-voltage electric power transmission assembly with a high-voltage offshore cable that is better suited for power transmission offshore.

Another object of the present invention may be to provide a high-voltage electric power transmission assembly with a high-voltage offshore cable that has a reduced serial impedance compared to comparable cables.

A further object of the invention may be to provide a high-voltage electric power transmission assembly with a high-voltage offshore cable that has a reduced risk of failure of the power cores of the cable.

Yet another object of the present invention may be to provide a high-voltage electric power transmission assembly with a high-voltage offshore cable that is less exposed to AC corrosion resulting from induced voltage in the cable.

### SUMMARY OF INVENTION

According to the present invention, there is provided an offshore high-voltage electric power transmission assembly. The assembly comprises a power supply at a first location, wherein the power supply comprises P supply phase lines and wherein the power supply is an AC power supply. The assembly has a power-receiver at a second location, wherein the power receiver comprises P receiving phase lines. Furthermore, the assembly has a high-voltage offshore cable arranged between the power supply and the power receiver to transmit electric power. The first location and/or the second location is an offshore location. According to the invention, the high-voltage offshore cable comprises P×N power cores, wherein N=2 or more, and wherein P=2 or more. N groups each having P power cores connect to the respective P supply phase lines of the power supply and to the respective P receiving phase lines of the power receiver. The P×N power cores are distributed along a core distribution circle in the cross-section of the high-voltage offshore cable. Moreover, the order of the P power cores within each of the N groups is identical.

By stating that the order of the P power cores within each of the N groups is identical is meant that the sequence of the P power cores is repeated for each of the N groups. For instance, for a three-phase system with three power cores (P=3) termed a, b, c in each group and having two groups (N=2), the sequence of the six power cores along the core distribution circle will be a-b-c-a-b-c.

In some embodiments, the power cores of the high-voltage offshore cable are wound in a helix configuration.

In some embodiments, the high-voltage offshore cable can comprise elongated strength members, wherein one or more elongated strength members can be arranged radially within the core distribution circle. Moreover, the high-voltage offshore cable can comprise a vertically extending cable portion that extends through a body of water.

In such embodiments, the vertically extending cable portion will be exposed to tension. The high-voltage offshore cable can also be exposed to tension also even if not having said vertically extending cable portion, such as during installation.

Power cores that are helically wound and arranged further away from the cable center than comparable prior designs will be less affected by such tension.

In some embodiments, the high-voltage offshore cable can further comprise one or more fluid pipes that are arranged radially within the core distribution circle.

By arranging the fluid pipe radially within the power cores, the fluid pipe will be less exposed to fatigue. Moreover, the fluid pipes will be kept warmer since they are arranged further from the (cold) outer surface of the high-voltage offshore cable. Moreover, by arranging them radially within the power cores, they will be heated due to the heat generated in the power cores.

Furthermore, the fluid pipe and possible other metal members located radially within the power cores, preferably close to the center, will be less exposed to induced voltage and hence AC corrosion. This is because the magnetic field is weak due to cancelation from the fields from the power cores.

The high-voltage offshore cable may further comprise a plurality of cooling tubes, wherein the cooling tubes are distributed along a cooling tube distribution circle that is arranged radially within the core distribution circle in the cross-section of the high-voltage offshore cable.

With the term cooling tube is meant a fluid-carrying tube that cools the high-voltage offshore cable. Advantageously, the fluid can be supplied to the cooling tube from a cooled fluid source.

In some embodiments including said cooling tubes, the number of cooling tubes arranged along the cooling tube distribution circle is P×N. In other words, the number of cooling tubes can be identical to the number of power cores.

The high-voltage offshore cable may further comprise a fiber optic monitoring cable configured for monitoring of parameters of the high-voltage offshore cable. The fiber optic monitoring cable can be arranged radially outside of the core distribution circle.

In some embodiments, N is 3 or more. In such embodiments, for instance if N is 4, a three-phase system would comprise 12 (namely 3×4) power cores in the high-voltage offshore cable.

In some embodiments, the power supply and/or the power receiver comprises a termination assembly located at a subsea location, wherein the termination assembly comprises N×P connectors that connect to the respective power cores. Compared to for instance 3-phase power systems of the prior art, the number of connectors is thus increased. However, by increasing the number of connectors, one is able to use connectors with lower ratings. This increases the variety of available and qualified connectors.

In some embodiments, the power cores can be distributed about a cable center with mutual core angles between the respective power cores within one group of power cores, and with mutual group angles between succeeding groups of power cores, wherein the mutual core angles within one group of power cores are identical.

Furthermore, the mutual group angles can be different from the mutual core angles.

In embodiments where the high-voltage offshore cable comprises said vertically extending cable portion, the vertically extending cable portion can extend between locations that is at least 30, 170 or even 3000 meters vertically apart. Such vertical distances will result in significant tensional forces in the high-voltage offshore cable during installation and/or during operation.

As stated above, the power cores, and possibly also the elongated strength members, can be wound in a helix configuration. This includes embodiments where they are wound in an alternating helix configuration (sometimes in the art referred to as “Oscilay”)/SZ-configuration.

With the term power supply is meant a supply of electric AC power, such as for instance the end of a supply cable, which may be part of the assembly according to the invention. Correspondingly, the power receiver can for instance be the end of an electric cable, to which electric AC power is delivered.

With the term high voltage is herein meant voltages above 5 kV, or even above 17 kV.

In some embodiments, the AC power supply is rated to supply power above 3 MW.

With the term strength element is herein meant an integrated component of the high-voltage offshore cable that is included for increasing or providing longitudinal integrity of the cable. Thus, for instance, a control line for transmitting control signals or a fluid pipe for transmitting fluid or a fluid pressure, is not considered as a strength element according to this definition.

Due to the design of the high-voltage offshore cable, used as a part of the assembly according to the invention, one achieves power transmission with lower serial impedance than when using common cables of the prior art. In some embodiments, this will enable the use of a wet design cable instead of a dry design. This is because an excessive loss in the cable, typically taking place with longer cables of the known type, is normally mended by applying a dry design. A dry design can tolerate higher voltages, which is used to lower the losses. With the solution according to the invention, however, due to the cable design one can maintain a wet design while still having comparably lower losses in the cable.

### DETAILED DESCRIPTION OF THE INVENTION

While various features of the invention have been discussed in general terms above, a more detailed example of embodiment will be presented in the following with reference to the drawings, in which

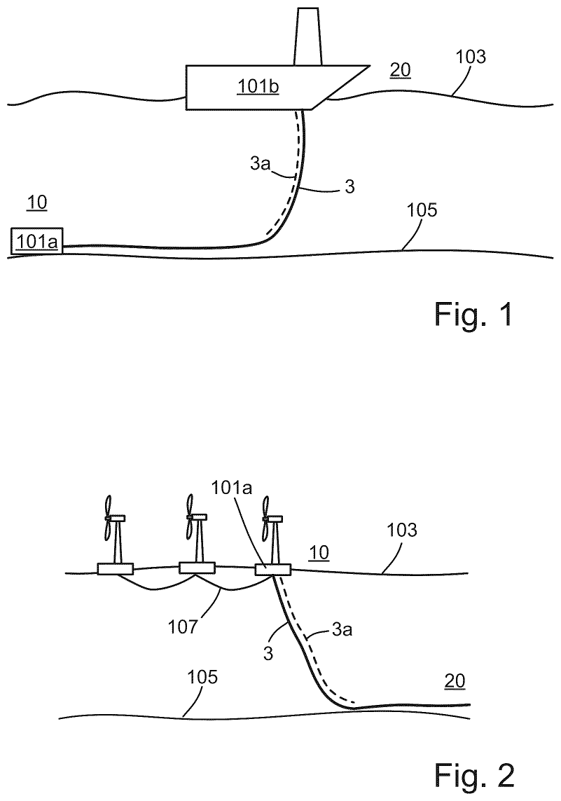

FIG. 1 is a principle view of a floating surface structure in form of a vessel, from which a high-voltage offshore cable depends towards the seabed;

FIG. 2 is another principle view, showing a plurality of electrically connected floating wind turbines, wherein a high-voltage offshore cable depends from one of the wind turbines and down to the seabed;

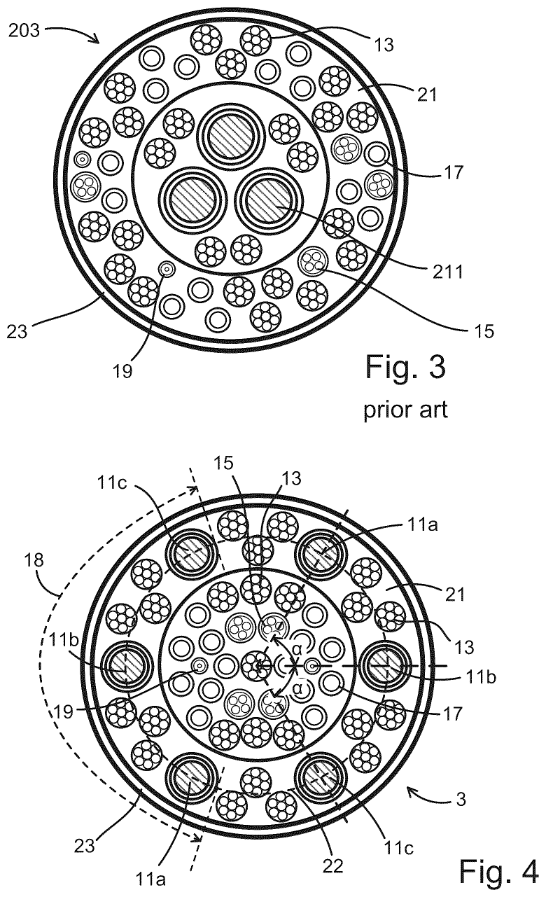

FIG. 3 is a cross section view through a 3-phase high-voltage offshore power cable according to prior art;

FIG. 4 is a cross section view through a 3-phase high-voltage offshore power cable being part of the novel assembly according to the invention;

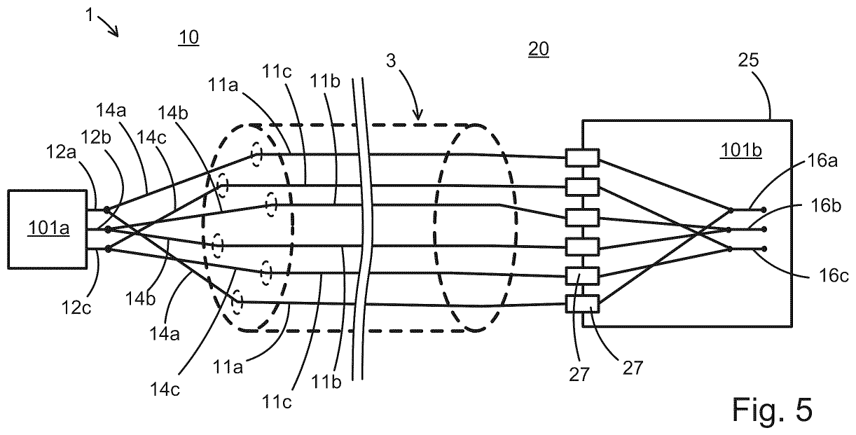

FIG. 5 is a schematic diagram showing an assembly according to the present invention;

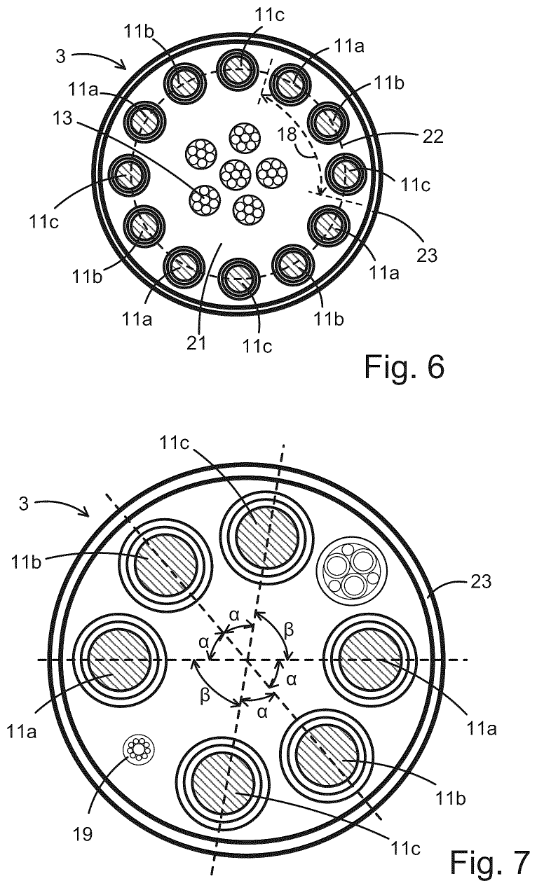

FIG. 6 is a cross section view through another embodiment of a high-voltage offshore cable that is suitable as part of the assembly according to the invention;

FIG. 7 is a cross section view through another high-voltage offshore cable that is suitable as part of the assembly according to the invention; and

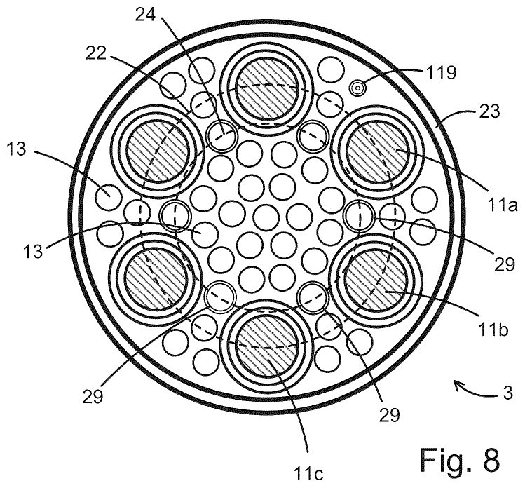

FIG. 8 depicts a further high-voltage offshore cable that is provided with a plurality of cooling tubes.

FIG. 1 illustrates, with a schematic diagram, a possible application of an offshore high-voltage electric power transmission assembly according to the present invention. In this embodiment, a ship 101b, such as an FPSO, is floating on the sea surface 103. A high-voltage offshore cable 3 extends from the seabed 105 and up to the ship 101b. In this embodiment, the ship 101b is a power receiver, as it receives electric power through the high-voltage offshore cable 3 from a power supply 101a at a first location 10, while the ship 101b is located at a second location 20. While the first location 10 in the shown image is a subsea location, it could instead be an onshore location (not shown). The distance between the first and second locations 10, 20 can be for instance 500 m, several kilometers, or even tens of kilometers. Furthermore, in the shown embodiment the high-voltage offshore cable 3 has a vertically extending cable portion 3a, indicated with the dashed line. In this embodiment, the vertically extending cable portion 3a extends a vertical distance that substantially corresponds to the sea depth.

FIG. 2 depicts another possible application of an offshore high-voltage electric power transmission assembly according to the invention. In this embodiment, a plurality of offshore wind turbines 101a are interconnected with a connection cable 107. The electric power that is generated by the wind turbines 101a is transferred from a first location 10, where the wind turbines 101a (or at least one of the wind turbines) are located, to a second location 20, through the high-voltage offshore cable 3. As with the example shown in FIG. 1, the high-voltage offshore cable 3 has a vertically extending cable portion 3a that has vertical extension through the water, indicated with the dashed line.

Since the high-voltage offshore cable 3 has a significant weight, it must be capable of carrying its own weight along a vertical distance in the sea. Moreover, in embodiments wherein the vertically extending cable portion 3a is used as a dynamic cable, it must also tolerate forces resulting from repeating cable movements. Such movements can be induced for instance by water currents or waves.

FIG. 3 depicts a schematic cross section view through a high-voltage offshore cable 203 of the prior art. This type of cable is often referred to as a power umbilical. It comprises three power cores 211, which typically are made of copper. The three power cores 211 are centrally arranged close to the center of the high-voltage offshore cable 203 and are configured to transfer three-phase electric power. By arranging the power cores 211 close together, one reduces the electric and magnetic fields occurring radially outside the group of the three power cores 211.

Radially outside of the three power cores 211 there are arranged a plurality of further elongated elements. Strength members 13 are arranged for increasing the axial strength of the high-voltage offshore cable 203. Control cables 15 are included for enabling electric control of various equipment, such as sensors and actuators (not shown). Also included are fluid pipes 17 and fiber optic cables 19.

Between the various functional elements, there are arranged elongated filler elements 21. All elements are kept in position and protected by an outer sheath 23.

The various elongated elements are provided with a helical/helix configuration, such that they exhibit a spiral-shaped extension about the center axis of the high-voltage offshore cable 203. The helical configuration may be alternately laid or may have a continuous helical configuration.

When a helically wound, high-voltage offshore cable is tensioned due to its own weight, for instance as occurring in the embodiments depicted in FIG. 1 and FIG. 2, it tends to unwind. As discussed above, this results in increased tension in the centrally arranged members of the cable. As a result, an increased amount of strength members 13 are used, so that the power cores 211 are not exposed to excessive tension.

FIG. 4 depicts a cross section through a high-voltage offshore cable 3 used with an embodiment of the present invention. It comprises several components that are identical or corresponding to the components shown in the prior art example of FIG. 3. However, while the prior art high-voltage offshore cable 203 of FIG. 3 comprises three power cores 211 arranged centrally close to the cable center, the high-voltage offshore cable 3 has a different configuration.

The high-voltage offshore cable 3 shown in FIG. 4 has six power cores 11a, 11b, 11c. Compared to the prior art embodiment, the total cross-section area of each of the six power cores 11a, 11b, 11c is less than the total cross-section area of the three power cores 211 of the embodiment shown in FIG. 3. In fact, due to reduced inductance, more electric power can be transferred in the high-voltage offshore cable 3 shown in FIG. 4 than with the cable shown in FIG. 3, even with less total cross section area of the power cores 11a, 11b, 11c.

Moreover, the power cores 11a, 11b, 11c are arranged closer to the outer sheath 23, thus rendering available an area at the location of the cable center. The power cores 11a, 11b, 11c are distributed along a core distribution circle 22 extending substantially parallel to the outer sheath 23.

Furthermore, in the shown embodiment, the six power cores 11a, 11b, 11c are distributed with an even mutual core angle a and an even distance between the respective neighboring power cores 11a, 11b, 11c. Hence, since the high-voltage offshore cable 3 of the present embodiment has six power cores 11a, 11b, 11c, the mutual core angles a between the respective power cores is 60°.

As will be shown with reference to another embodiment later, however, other embodiments may have mutual core angles a that are not even.

In the embodiment shown in FIG. 4, the high-voltage offshore cable 3 has two identical ensembles 18 of power cores 11a, 11b, 11c. Each ensemble 18 comprises three power cores 11a, 11b, 11c. The six power cores 11a, 11b, 11c are thus, in the shown embodiment, distributed as two identical ensembles 18 that succeed each other along the core distribution circle 22 that extends about the center axis of the high-voltage offshore cable 3. In the shown embodiment, the order of distribution of the power cores within one ensemble 18 is 11a-11b-11c. The succeeding identical ensemble 18 thus also has the same order, namely 11a-11b-11c. Consequently, since the embodiment has two succeeding ensembles 18, the total distribution of the six power cores is then 11a-11b-11c-11a-11b-11c. By stating that the ensembles 18 are identical, it is meant that they comprise the same number of power cores, and that the order of these respective power cores is identical in each ensemble 18.

Contrary to the prior art example shown in FIG. 3, the high-voltage offshore cable 3 shown in FIG. 4 comprises strength members 13 that are arranged radially within the position of the power cores 11a, 11b, 11c. I.e., the strength members 13 are located radially within the core distribution circle 22. Consequently, when the high-voltage cable 3 is exposed to tension, such as during installation in the sea, the strength members 13 arranged radially within the power cores 11a, 11b, 11c will be strained more than the members radially outside of them, such as the power cores.

As a result, the power-conducting power cores 11a, 11b, 11c are better protected against excessive tension.

Furthermore, by arranging the power cores 11a, 11b, 11c closer to the outer sheath 23, they will be better cooled by the ambient sea water. A cooler power core will have less electrical resistance and consequently less power loss. This is particularly relevant for high-voltage offshore cables of a significant length.

A further advantage of the embodiment shown in FIG. 4, where the high-voltage offshore cable 3 comprises fluid pipes 17, is that the fluid pipes 17 are kept warmer, since they are arranged radially within the power cores 11a, 11b, 11c. This can be an advantage such as when a viscous liquid is present inside the fluid pipe 17, as the temperature in the sea, and in particular close to the seabed, can be relatively low, such as about 4° C.

FIG. 5 is a schematic diagram illustrating an embodiment of an offshore high-voltage electric power transmission assembly 1. At a first location 10, the assembly comprises a 3-phase power supply 101a. The power supply 101a is a high-voltage power supply configured to deliver electric power to the shown high-voltage offshore cable 3. The high-voltage offshore cable 3 extends between the first location 10 and a second location 20.

In this embodiment, as well as other embodiments, one or both of the first and second locations 10, 20 is an offshore location. Moreover, one or both of the first and second locations 10, 20 can be located at the sea surface 103 or at the seabed 105. Hence, for instance, the first location 10 can be at the sea surface 103 while the second location is at the seabed 105. Or, in alternative embodiments, the first location 10 can for instance be onshore, while the second location 20 is offshore, either at the sea surface 103 or at the seabed 105. Indeed, the first and/or second location can also be arranged offshore, and with a vertical distance from both the seabed 105 and the sea surface 103.

Although not indicated in the schematic illustration of FIG. 5, at least a portion of the high-voltage offshore cable 3 could comprise a vertically extending cable portion 3a which is located in the sea with a vertical extension, such as shown in FIG. 1 and in FIG. 2. With the term vertical extension, it shall be understood not only a strictly vertical direction, but also a direction that is inclined with respect to the horizontal direction. Such a portion of the high-voltage offshore cable 3 will experience tension during installation and/or during operation.

Still referring to FIG. 5, three supply phase lines 12a, 12b, 12c extend out from the 3-phase power supply 101a. These three supply phase lines 12a, 12b, 12c are split into three pairs of phase branches 14a, 14b, 14c, such that two phase branches 14a, 14b, 14c exist for each of the three supply phase lines 12a, 12b, 12c.

Each of the phase branches 14a, 14b, 14c connects to a respective power core 11a, 11b, 11c of the high-voltage offshore cable 3. In this manner, the 3-phase power is transported from the power supply 101a, through three pairs of power cores 11a, 11b, 11c from the first location 10 to a power receiver 101b at the second location 20.

At the second location 20, which in this embodiment is a subsea location, i.e. a location at the seabed 105, the electric power is transferred through a termination assembly 25. The termination assembly 25 can be for instance connect to a subsea load and represents the power receiver 101b in the present embodiment.

At the second location 20, the electric power is transferred to the termination assembly 25 through connectors 27 arranged as part of the termination assembly 25. In the termination assembly 25, the six conductors from the connectors 27 are joined into three receiving phase lines 16a, 16b, 16c.

For large electric, three-phase power transmissions, the use of six connectors 27 at the subsea location is advantageous, since a larger selection of qualified subsea connectors exist for lower power ranges than for larger power ranges. Hence, by increasing, e.g. doubling, the number of connectors 27 (i.e. six connectors instead of three) the power rating for each connector can be reduced accordingly.

FIG. 6 depicts a cross section through an alternative high-voltage offshore cable 3 that is a part of the offshore high-voltage electric power transmission assembly 1 according to the invention. In this embodiment, the high-voltage offshore cable 3 is configured to transfer 3-phase electric power, such as shown with the embodiment illustrated in FIG. 5. However, instead of having six power cores 11a, 11b, 11c as in FIG. 4 and in FIG. 5, wherein two power cores transfer one electric phase, the high-voltage offshore cable 3 shown in FIG. 6 comprises 12 power cores 11a, 11b, 11c. Thus, each of the three electric phases is split into four power cores.

The twelve power cores 11a, 11b, 11c are distributed along the core distribution circle 22, which extends about a central portion of the high-voltage offshore cable 3. At the central portion, radially within the power cores 11a, 11b, 11c there is arranged six strength members 13.

Although not indicated in FIG. 6, in this embodiment the mutual core angles a between the neighboring power cores are identical.

If the high-voltage offshore cable 3 shown in FIG. 6 would be used with the embodiment shown with reference to FIG. 5, each of the three supply phase lines 12a, 12b, 12c would thus be split into four phase branches 14a, 14b, 14c. These twelve phase branches 14a, 14b, 14c would then further connect to the twelve power cores 11a, 11b, 11c.

As will be appreciated by the skilled reader, the number power cores in the high-voltage offshore cable 3 can be expressed as the multiple of the number of supply phase lines 12a, 12b, 12c and the number of phase branches 14a, 14b, 14c for each supply phase line. For instance, if the number of supply phase lines 12a, 12b, 12c is P and the number of phase branches 14a, 14b, 14c for each supply phase line is N, then the number of power cores is P×N. With the embodiment shown in FIG. 4 and FIG. 5, P×N=3×2=6 power cores. With the embodiment shown in FIG. 6, P×N=3×4=12 power cores.

Referring to FIG. 6, the shown high-voltage offshore cable 3 has four identical ensembles 18 (i.e., 4 groups of power cores, with N=4), wherein each ensemble 18 has three power cores 11a, 11b, 11c. Since the four identical ensembles 18 or groups of power cores succeed each other along the core distribution circle 22, the distribution of the twelve power cores is then as follows: 11a-11b-11c-11a-11b-11c-11a-11b-11c-11a-11b-11c.

Reference is now made to FIG. 7, which depicts an embodiment of a high-voltage offshore cable 3 with two groups of three power cores 11a, 11b, 11c. In this embodiment, the mutual core angles α between the respective power cores 11a, 11b, 11c within one group are identical. A mutual group angle β is also indicated, which is the angle between two neighboring power cores of succeeding groups of power cores. Hence, as indicated in FIG. 7, the mutual group angles β are indicated between the power core termed 11c of one group and the power core 11a of the neighboring group. Furthermore, the group angles β are different than the mutual core angles α. As shown in this embodiment, the group angles β are larger than the mutual core angles α. In the shown embodiment, the groups angles β are identical, and the mutual core angles α are identical.

FIG. 8 depicts a cross section view of another high-voltage offshore cable 3 that can be a part of the offshore high-voltage electric power transmission assembly 1 according to the invention. In this embodiment, the high-voltage offshore cable 3 comprises cooling tubes 29. Moreover, in this embodiment, the number of cooling tubes 29 is identical to the number of power cores 11a, 11b, 11c (namely six in the shown embodiment).

While the power cores 11a, 11b, 11c are distributed along the core distribution circle 22, as discussed above, the cooling tubes 29 are distributed along a cooling tube distribution circle 24. Moreover, the cooling tube distribution circle 24 is arranged inside the core distribution circle 22 and preferably substantially in parallel with the core distribution circle 22.

As shown in FIG. 8, one or more strength members 13 can be arranged within the cooling tube distribution circle 24.

This configuration of the cooling tubes 29, along the cooling tube distribution circle 24, will prevent heat generated in the power cores 11a, 11b, 11c from excessively heating the strength members 13 or any other components arranged at the central portion of the high-voltage offshore cable 3. Furthermore, the cooling tubes 29 will enable the operator to control the temperature in the power cores 11a, 11b, 11c. This will in turn enable a reduced impedance of the power cable and hence lower power loss.

Still referring to FIG. 8, radially outside the core distribution circle 22 there is arranged a fiberoptic monitoring cable 119. The fiberoptic monitoring cable 119 can be used for temperature monitoring inside the high-voltage offshore cable 3. The fiberoptic monitoring cable 119 may instead or in addition be used for acoustic monitoring. In this manner, the operator is enabled to monitor physical movements, such as vibrations, of the high-voltage offshore cable 3.

The offshore high-voltage electric power transmission assembly according to the invention, such as the embodiments discussed above, the cooling tubes 29 can be supplied with a cooling fluid from a cooled fluid source (not shown). The cooled fluid source can be an apparatus that prepares the fluid to be inserted into the cooling tubes 29 by lowering the cooling fluid temperature to a set temperature. In this manner, the operator can control the temperature inside the high-voltage offshore cable 3 by adjusting the temperature of the cooling fluid supplied to the cooling tubes 29. Such adjustment can also be done by adjusting the flow of the cooling fluid through the cooling tubes 29.

1. An offshore high-voltage electric power transmission assembly, comprising
a power supply at a first location wherein the power supply comprises P supply phase lines, and wherein the power supply is an AC power supply;
a power-receiver at a second location, wherein the power receiver comprises P receiving phase lines; and
a high-voltage offshore cable, arranged between the power supply and the power receiver to transmit electric power;
wherein the first location and/or the second location is an offshore location, and wherein
the high-voltage offshore cable comprises P×N power cores, wherein N=two or more, and wherein P=two or more;
N groups of P power cores connect to the respective P supply phase lines of the power supply and to the respective P receiving phase lines of the power receiver;
the P×N power cores are distributed along a core distribution circle in the cross-section of the high-voltage offshore cable; and
the order of the P power cores within each of the N groups is identical.

2. An offshore high-voltage electric power transmission assembly according to claim 1, wherein the power cores of the high-voltage offshore cable are wound in a helix configuration.

3. An offshore high-voltage electric power transmission assembly according to claim 1, wherein the high-voltage offshore cable further comprises elongated strength members, wherein one or more elongated strength members are arranged radially within the core distribution circle.

4. An offshore high-voltage electric power transmission assembly according to claim 1, wherein the high-voltage offshore cable further comprises one or more fluid pipes that are arranged radially within the core distribution circle.

5. An offshore high-voltage electric power transmission assembly according to claim 1, wherein the high-voltage offshore cable further comprises a plurality of cooling tubes, wherein the cooling tubes are distributed along a cooling tube distribution circle that is arranged radially within the core distribution circle in the cross-section of the high-voltage offshore cable.

6. An offshore high-voltage electric power transmission assembly according to claim 5, wherein the number of cooling tubes arranged along the cooling tube distribution circle is P×N.

7. An offshore high-voltage electric power transmission assembly according to claim 1, wherein the high-voltage offshore cable further comprises a fiber optic monitoring cable configured for monitoring of parameters of the high-voltage offshore cable, wherein the fiber optic monitoring cable is arranged radially outside of the core distribution circle.

8. An offshore high-voltage electric power transmission assembly according to one claim 1, wherein N is three or more.

9. An offshore high-voltage electric power transmission assembly according to claim 1, wherein the power supply and/or the power receiver comprises a termination assembly located at a subsea location, wherein the termination assembly comprises N×P connectors that connect to the respective power cores.

10. An offshore high-voltage electric power transmission assembly according to claim 2, wherein the high-voltage offshore cable comprises a vertically extending cable portion that extends between locations that are at least 30 meters vertically apart.

11. An offshore high-voltage electric power transmission assembly according to claim 1, wherein the power cores are distributed about a cable center with mutual core angles (α) between the respective power cores within one group of power cores, and with mutual group angles (β) between succeeding groups of power cores, wherein the mutual core angles (α) within one group of power cores are identical, and wherein the mutual group angles (β) are different from the mutual core angles (α).
